(19) United States
(12) Patent Application Publication
(10) Pub. No.: US 2008/0128445 A1
(43) Pub. Date: Jun. 5, 2008

(54) Dispenser having advertisement counting effect

(76) Inventors: Hsi Ping Huang, Hsi-Tsu (TW); Sofiane Rachedi, Palavas les Flots (FR)

Correspondence Address: Hsi Ping Huang, P. O. Box 55-846, Taipei, 104, omitted

(21) Appl. No.: 11/633,331

(22) Filed: Dec. 5, 2006

(51) Int. Cl. G07F 11/00

(52) U.S. Cl. 221/7

(57) ABSTRACT

A dispenser comprises: a housing having a biasing plate formed in a lower portion in the housing; and a dispensing cassette secured in the housing having an advertisement feature formed on a front plate of the dispensing cassette and having a quantitative plurality of stacking articles such as coffee stirrers or foods or medical devices stacked and stored in the cassette; whereby upon an inward depression of the cassette, the lowest article will be biased by the biasing plate and discharged outwardly; and upon each depression on the cassette by the user, the user may “read” the advertisement feature on the front plate simultaneously for an advertisement effect.

### BACKGROUND OF THE INVENTION

U.S. Pat. No. 5,381,925 disclosed a dispenser for containing and dispensing elongated articles such as coffee stirrers, straws and the like.

However, such a prior art has the following drawbacks:
1. For dispensing the article, an operating knob must be rotated either rightwardly or leftwardly, which may cause difficulty for a disabled person unable for rotating the knob.
2. The article (28) such as straw or coffee stirrer is downwardly fed into the dispensing groove (57) through an inclined or arcuate wall (30). So, the article (28) should be preferably made as a round piece for a smooth downward rolling. Otherwise, if the article (28) is a flat plate, it may be frictionally retarded by another neighboring article or be frictionally stagnant on the wall, causing unsmooth dispensing operation.
3. It is not provided with any advertisement counting mechanism or idea on the dispenser, thereby being unable for checking an advertisement effect with respect to the advertisement-reading times by the users.

The present inventor has found the drawbacks of the prior art and invented the present dispenser having advertisement effect.

### SUMMARY OF THE INVENTION

The object of the present invention is to provide a dispenser comprising: a housing having a biasing plate formed in a lower portion in the housing; and a dispensing cassette resiliently pivotally or movably secured to the housing having an advertisement feature formed on a front plate of the dispensing cassette and having a quantitative plurality of stacking articles such as utensils (e.g., coffee stirrer) or foods (such as chewing gum) or medical devices stacked and stored in the cassette; whereby upon an inward depression of the cassette, the lowest article will be biased by the biasing plate and discharged outwardly through a slot formed through the front plate; and upon each depression on the cassette by the user, the user may “read” the advertisement feature on the front plate simultaneously to thereby have an additional effect for counting the advertisement-reading times by the user in order for checking an advertisement effect.

### BRIEF DESCRIPTION OF THE DRAWINGS

FIG. 1 is a perspective view of the present invention.

FIG. 2 is a side-view sectional drawing of the present invention.

FIG. 3 is a cross sectional drawing showing the stackable article with the biasing plate in the present invention.

FIG. 4 shows a depression of the present invention for biasing and dispensing the article following FIG. 3.

FIG. 5 is a front view of an interior of the present invention when the dispensing cassette is removed.

FIG. 6 shows the dispensing cassette from an inside view of the cassette.

FIG. 7 is a top view of the pusher weight in the dispensing cassette of the present invention.

FIG. 8 shows another preferred embodiment of the present invention.

FIG. 9 is a partial side-view sectional drawing as viewed from FIG. 8.

FIG. 10 shows an electric block diagram as used in FIG. 8 of the present invention.

FIG. 11 shows still another preferred embodiment of the present invention.

FIG. 12 shows the biasing plate and the stackable article in the present invention of FIG. 11.

FIG. 13 shows the dispensing operation following FIG. 12.

FIG. 14 shows a modified biasing plate from FIG. 11.

FIG. 15 shows another modification of the present invention from FIG. 11.

FIG. 16 is a perspective view of the pusher weight in FIG. 11,

### DETAILED DESCRIPTION

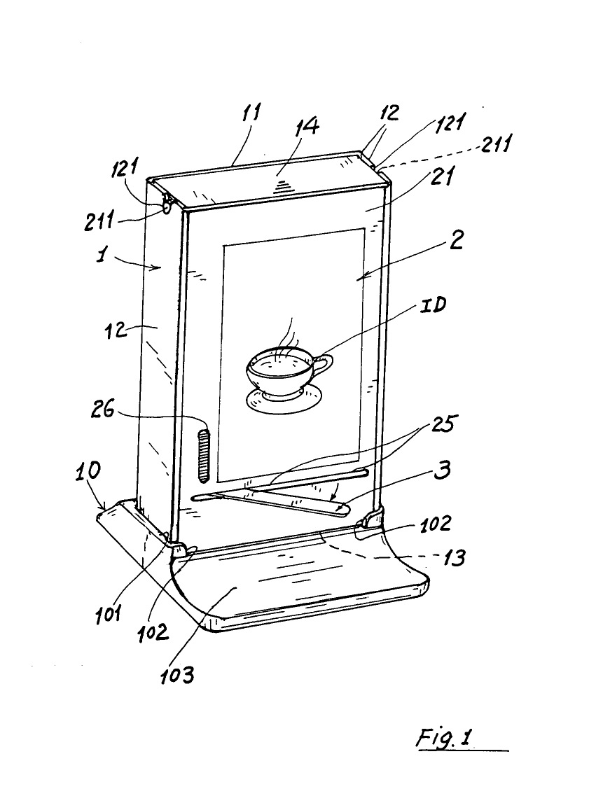

As shown in FIGS. 1˜7, the dispenser of the present invention comprises: a housing 1; and a dispensing cassette 2 formed in the housing 1 and having a plurality of stacking articles 3 stored in the dispensing cassette 2.

The stacking article 3 is preferably formed as elongated shape or flat piece easily stacked or superimposed within the dispensing cassette 2.

The stacking article 3 may include: coffee stirrer, spoon, fork, knife, condom, syringe, spatule, chopsticks, match, chocolate, candy, compress, bandage, ear plugs, tooth picks, tampon, sanitary napkin, cotton bud, chewing gum, CD, DVD, mask, etc.

Accordingly, the stacking (or stackable) articles 3 may serve for foods, utensils or tools for stirring beverage or seasoning, medical goods or daily-use commodities.

The stacking article 3 may be made of wood, plastic, paper or other suitable materials, if provided for utensils or tools.

The present invention may be installed or provided in public places, including coffee shop, restaurant, bar, supermarket, kiosk, railway station, airport, automatic vending machine, etc. It can be placed on a table or fixed, fastened, hung or magnetically attracted on a wall, not limited in the present invention.

The housing 1 may be formed as parallelepiped or rectangular shape, and includes: a back plate 11; a pair of side plates 12 disposed on opposite sides of the back plate 11 to define a U shape of a cross section of the back plate 11 and the two side plates 12; a bottom plate 13 formed on a bottom of the back plate 11 and the two side plates 12; a top cover 14 pivotally formed or formed on a top of the back plate 11 and the two side plates 12 for covering the plates 11, 12 and the dispensing cassette 2 formed herein; a biasing plate 15 formed on a lower portion of the back plate 11; and a tension spring 16 formed on a lower portion of the back plate 11 and positioned under the biasing plate 15 and normally urging the cassette 2 outwardly.

The housing 1 further includes: a holder 10 formed or embedded on a bottom portion of the housing 1 (including the bottom plate 13); a pair of lugs 102 formed on a front portion of the holder 10 for limiting the housing 1; and a collector 103 protruding forwardly from the holder 10 for collecting the stacking articles 3 as downwardly discharged or released from the dispensing cassette 2.

The tension spring 16 may be jacketed thereon with a cap 161, which is flexible and may be made of elastic materials including rubber and plastic materials for a smooth operation of the present invention.

The dispensing cassette 2 includes: a front plate 21 corresponding to the back plate 11 of the housing 1; a pair of bottom legs 22 formed on a bottom of the front plate 21 and slidably engaged in a pair of grooves 131 recessed in a bottom plate 13 of the housing 1; a pair of sliding grooves 23 longitudinally formed on opposite end portions of the front plate 21 to define a U-shaped trough 20 for storing the stacking articles 3 as superimposed in the U-shaped trough 20; a pusher weight 24 slidably moving in the U-shaped trough 20 for gravitationally forcing the stacking articles 3 within the U-shaped trough 20; and an elongated slot 25 formed in a lower portion of the front plate 21 and corresponding to the biasing plate 15 formed in the housing 1; whereby upon an inward depression of the front plate 21, a lowest stacking article 3 in the dispensing cassette 2 will be thrusted outwardly by the biasing plate 15 to be downwardly discharged or released through the slot 25 to be collected by the collector 103 of the holder 10. The stacking articles 3 will be dispensed outwardly one by one upon each depression on the cassette 2.

A viewing window 26 is formed in a lower portion of the front plate 21 of the dispensing cassette 2 for observing and checking whether the stacking articles 3 are used up or not in the cassette 2 for re-filling of articles 3 into the cassette 2.

The cassette 2 has its two opposite side-wall portions tapered downwardly for a smooth depression of the front plate 21 of the cassette 2.

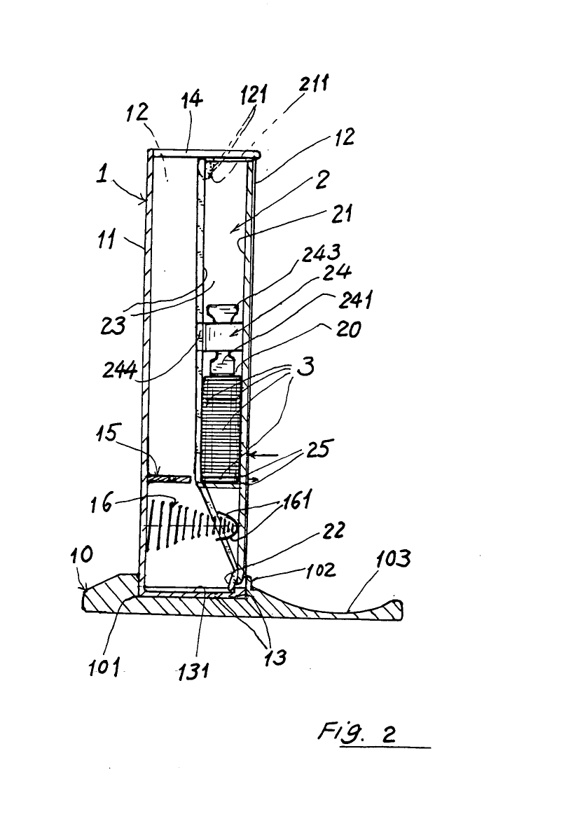

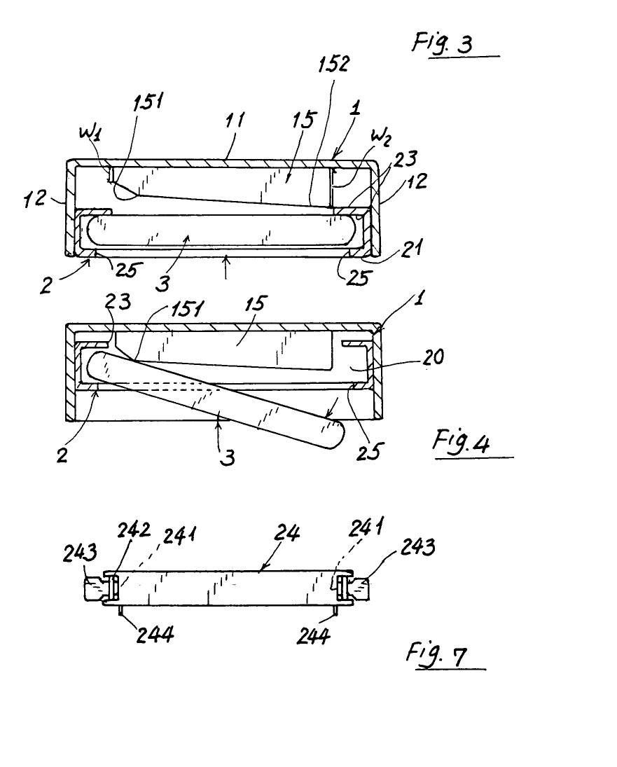

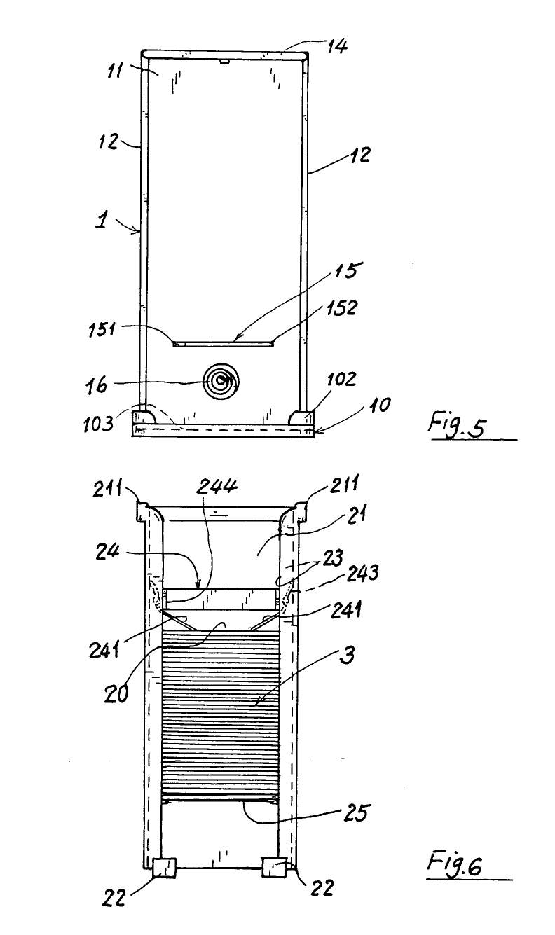

The front plate 21 includes a pair of pivots 211 formed on opposite upper portions of the front plate 21 to be respectively pivotally mounted in a pair of sockets 121 as formed in the two side plates 12 of the housing 1, thereby allowing an inward depression of the front plate 21 by pivoting the pivots 211 of the front plate 21 about the sockets 121 to allow the lowest stacking article 3 to be outwardly biased by the biasing plate 15 (FIG. 3 to FIG. 4) in order to downwardly discharge or release the stacking article 3.

The pusher weight 24 as shown in FIGS. 6, 7 includes: a pair of pushing arms 241 respectively pivotally mounted on two end portions of the pusher weight 24 by a pair of pins 242, and a pair of contacting pawls 243 each protruding sidewardly from each pushing arm 241 and movably engaged in each sliding groove 23 formed in the dispensing cassette 2, whereby upon a downward pressing on the stacking articles 3 by the pair of pushing arms 241 caused by the weight of the pusher weight 24, the stacking articles 3 will be forced to allow a lowest stacking article 3 to be biased outwardly by the biasing plate 15 when depressing the front plate 21 of the dispensing cassette 2.

The pair of contacting pawls 243 as movably engaged with the walls of the grooves 23 may help a stable downward pressing of the articles 3 and may also prevent from a reverse (or upward) movement of the articles 3 due to frictional contact of the pawls with the groove walls.

The pusher weight 24 further includes a pair of projections 244 slidably engaged with the edge portions of the pair of grooves 23 for stable gravitational movement of the weight 24 on the articles 3.

The biasing plate 15 includes: a narrow end portion W1 and a wide end portion W2 (W2>W1) disposed on opposite ends of the biasing plate 15, a biasing protrusion 151 adjacent to the narrow end portion W1; whereby upon an inward depression of the dispensing cassette 2 to allow the lowest stacking article 3 to be biased outwardly (FIG. 3 to FIG. 4) by the biasing protrusion 151, the article 3 will be biased outwardly through the slot 25 to be downwardly discharged and collected by the collector 103 of the holder 10. After releasing the depression, the spring 16 will restore the cassette 2 outwardly (FIG. 2), ready for next depression.

Upon each depression on the cassette 2 to obtain each article 3, the user may simultaneously watch the advertising feature ID as shown on the front plate 21 of the cassette 2 to thereby produce an advertising effect of the dispenser.

Since the cassette 2 is loaded with quantitative stacking articles 3, for instance, 50 pieces (or 100 pieces) for each loading into the cassette 2, the articles 3 when used up as checked through the viewing window 26 will also denote that 50 persons have ever taken the articles 3 and also “read” the advertising feature ID shown on the cassette, thereby having quantitative advertising effect.

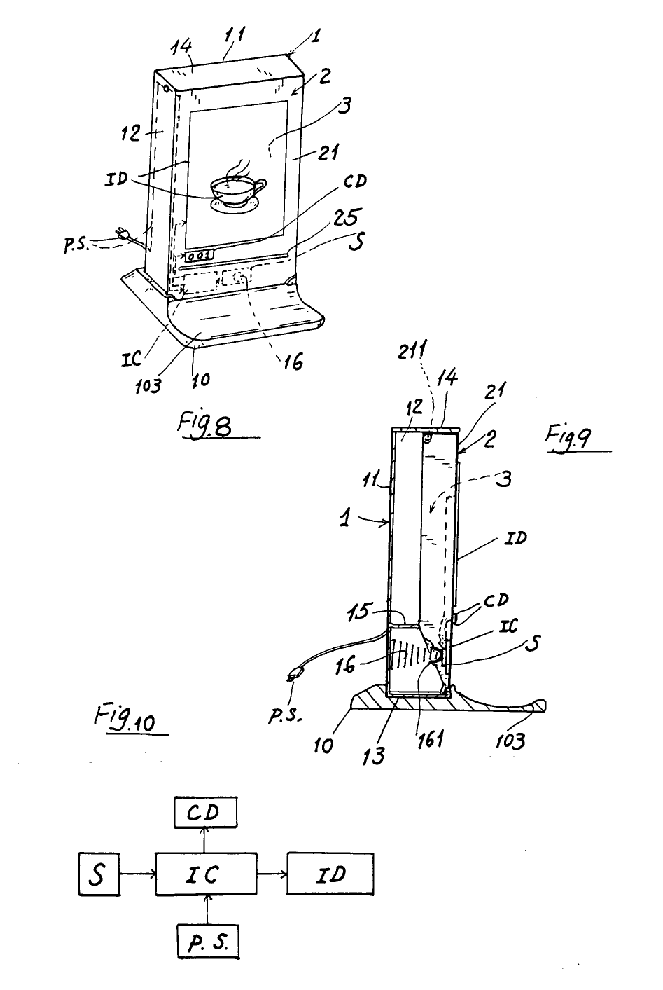

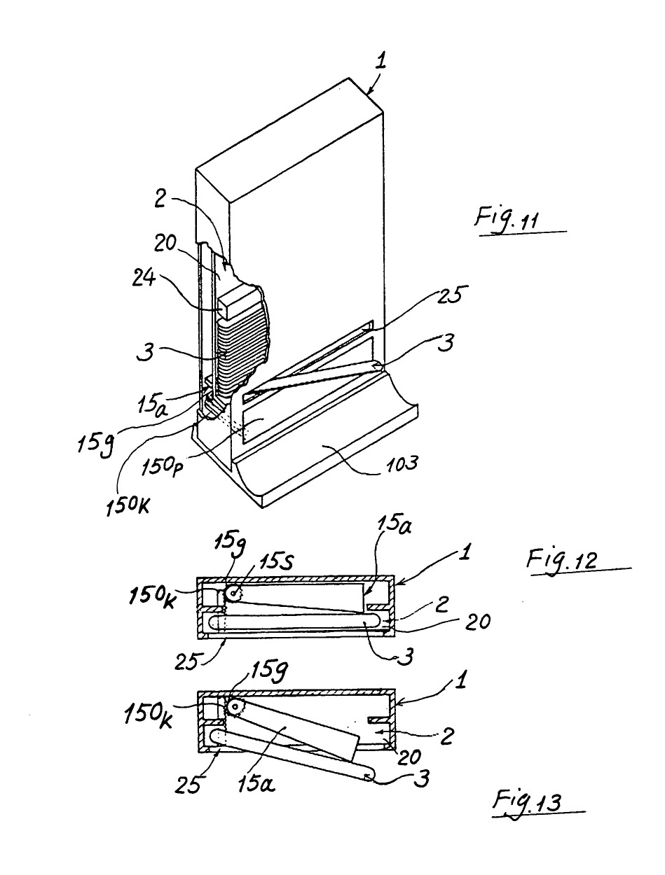

As shown in FIGS. 8˜10, the front plate 21 of the cassette 2 may be further provided with a trigger switch S, whereby upon inward depression of the front plate 21, the cap 161 as urged by the spring 16 will actuate the switch S to transmit an actuating signal, which will be sensed and controlled by an integrated circuit controller IC to start a counter display CD for counting the number of the depression in term of number of persons ever reading the advertisement feature which is shown on the image display ID simultaneously controlled by the integrated circuit controller IC. The image display ID may be designed both visually and audibly. The controller IC is powered by a power source P.S. as shown in FIG. 10.

As shown in FIGS. 11˜13, a modification of the present invention is made, in which, the biasing plate 15a is pivotally mounted in the housing 1 about a shaft 15s, a gear 15g coaxially secured to the shaft 15s and engaged with a rack 150k connected to the front plate 21 of the dispensing cassette 2, whereby upon an inward depression of the cassette 2 to allow the rack 150k to drive the gear 15g and bias the biasing plate 15a outwardly, the stacking article 3 will be pushed outwardly by the biasing plate 15a and discharged to be collected by the collector 103 of the holder 10.

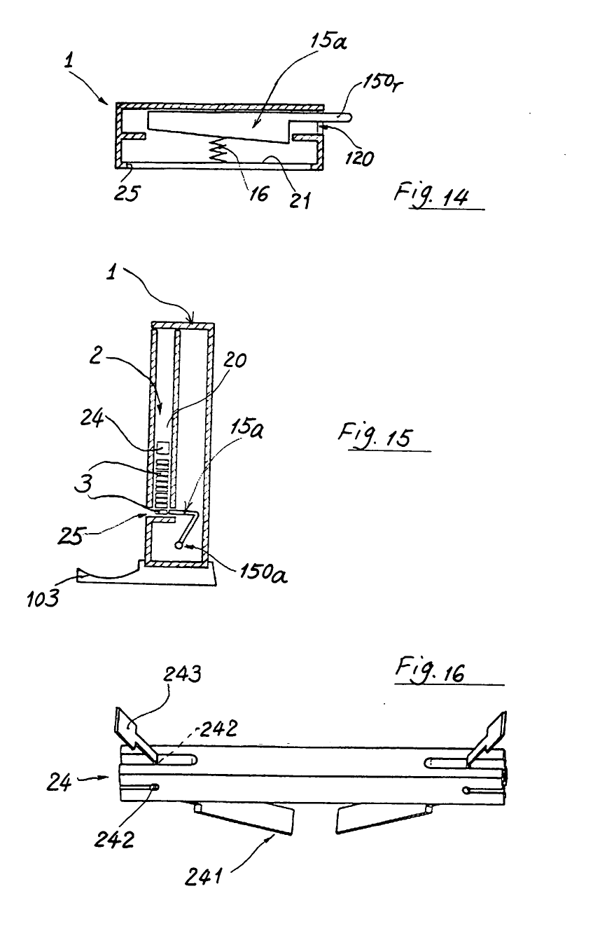

The biasing plate 15a as modified and shown in FIG. 14 includes a biasing handle 150r protruding sidewardly and outwardly through an opening 120 formed in a side wall 12 of the housing 1 and a spring 16 connected between the biasing plate 15a and the front wall 21 of the cassette 2, whereby upon an outward driving of the handle 150r, the biasing plate 15a will bias the stacking article 3 outwardly to be discharged and collected by the holder 10.

As shown in FIG. 15, the biasing plate 15a is connected with an actuating rod 150a, whereby upon operation (pushing or pulling) of the rod 150a to allow the biasing plate 15a to push the stacking article 3 outwardly, the article 3 will be discharged through the slot 25 and collected by the collector 103.

The pusher weight 24 as shown in FIG. 16 is a perspective view of the pusher weight 24, having each pushing arm 241 pivotally secured to the weight 24 by a pin 242 which is insertable into the weight 24.

The present invention has the following advantages superior to the prior art:
1. Just depressing or actuating the cassette 2 or biasing plate 15, the stacking article 3 will be smoothly dispensed, without rotating a knob as required by the prior art, thereby being easily operated, even by a disabled user.
2. Each depression for taking up each piece of article 3 is corresponding to each watching or reading on the advertising feature shown or displayed on the cassette 2, thereby rendering a quantitative advertising effect of the dispenser.
3. Since the stacking articles 3 are vertically stacked in the cassette 2, the shapes of the articles 3 are not limited so that a flat elongated article, such as shown in the drawings, may also be filled into the cassette, without being limited to a round straw or the like.

The present invention may be further modified without departing from the spirit and scope of the present invention.

For example, other dispensing mechanisms may be modified for ejecting, driving or moving the article 3 outwardly from the cassette 2.

The advertising feature ID may be displayed on any face or portion on the cassette 2 or housing 1, not limited in the present invention.

I claim:

1. A dispenser comprising:
a housing having an advertising feature displayed or shown on an outer surface of said housing;
a dispensing cassette formed in said housing and having a plurality of stacking articles superimposed in said cassette; and
means for actuating a lowest stacking article outwardly for dispensing said stacking article one by one from said cassette;
whereby upon each actuation for dispensing each said stacking article outwardly by a user, the advertising feature on said housing will be simultaneously read by the user upon his or her actuation each time to thereby obtain advertising counting effect.

2. A dispenser according to claim 1, wherein said stacking article includes: an utensil, a medical device, a stirrer, food, and a daily-use commodity.

3. A dispenser according to claim 1, wherein said stacking articles are quantitatively filled or loaded in said dispensing cassette.

4. A dispenser according to claim 1, wherein said housing includes:
a back plate; a pair of side plates disposed on opposite sides of the back plate to define a U shape of a cross section of the back plate and the two side plates for forming said dispensing cassette therein; a bottom plate formed on a bottom of the back plate and the two side plates; a top cover formed on a top of the back plate and the two side plates for covering said front and side plates and the dispensing cassette formed therein; a biasing plate formed on a lower portion of the back plate; and a tension spring formed on a lower portion of the back plate and positioned under the biasing plate and normally urging said cassette outwardly.

5. A dispenser according to claim 1, wherein said housing further includes: a holder formed on a bottom portion of the housing; a pair of lugs formed on a front portion of the holder for limiting the housing; and a collector protruding forwardly from the holder for collecting the stacking articles as downwardly discharged from the dispensing cassette.

6. A dispenser according to claim 4, wherein said tension spring is jacketed thereon with a cap, which is flexible and made of elastic materials.

7. A dispenser according to claim 4, wherein said dispensing cassette includes: a front plate corresponding to the back plate of the housing; a pair of bottom legs formed on a bottom of the front plate and slidably engaged in a pair of grooves recessed in a bottom plate of the housing; a pair of sliding grooves longitudinally formed in opposite ends of the front plate to define a U-shaped trough for storing the stacking articles as superimposed in the U-shaped trough; a pusher weight slidably moving in the U-shaped trough for gravitationally forcing the stacking articles within the U-shaped trough; and an elongated slot formed in a lower portion of the front plate and corresponding to the biasing plate formed in the housing; whereby upon an inward depression of the front plate, a lowest stacking article in the dispensing cassette will be thrusted outwardly by the biasing plate to be downwardly discharged through the slot to be collected by a collector of a holder.

8. A dispenser according to claim 7, wherein said cassette includes a viewing window formed in a lower portion of the front plate of the cassette for observing and checking the stacking articles stored in the cassette.

9. A dispenser according to claim 7, wherein said front plate includes a pair of pivots formed on opposite upper portions of the front plate to be respectively pivotally mounted in a pair of sockets formed in two side plates of the housing.

10. A dispenser according to claim 7, wherein said pusher weight includes: a pair of pushing arms respectively pivotally mounted on two end portions of the pusher weight by a pair of pins, and a pair of contacting pawls each protruding sidewardly from each pushing arm and movably engaged in each sliding groove formed in the dispensing cassette, whereby upon a downward pressing on the stacking articles by the pair of pushing arms caused by the weight of the pusher weight, the stacking articles will be forced to allow a lowest stacking article to be biased outwardly by the biasing plate when depressing the front plate of the dispensing cassette.

11. A dispenser according to claim 4, wherein said biasing plate includes: a narrow end portion and a wide end portion disposed on opposite ends of the biasing plate, and a biasing protrusion adjacent to the narrow end portion; whereby upon an inward depression of the dispensing cassette to allow the lowest stacking article to be biased outwardly by said biasing protrusion, the article will be biased outwardly through the slot to be downwardly discharged.

12. A dispenser according to claim 7, wherein said dispensing cassette further includes: a trigger switch provided in the front plate of the cassette; an integrated circuit controller electrically connected to said switch, whereby upon inward depression of the front plate, an actuating signal will be sensed and controlled by said integrated circuit controller to start a counter display for counting the number of the depression in term of number of persons ever reading the advertisement feature, and to start an image display simultaneously for showing an advertising feature.

13. A dispenser according to claim 1, wherein said housing includes a biasing plate pivotally mounted in the housing about a shaft, and a gear coaxially secured to the shaft and engaged with a rack connected to the front plate of the dispensing cassette, whereby upon inward depression of the cassette to let the rack to drive the gear and bias the biasing plate outwardly, the stacking article will be pushed outwardly by the biasing plate.

14. A dispenser according to claim 1, wherein said housing includes a biasing plate having a biasing handle protruding sidewardly and outwardly through an opening formed in a side wall of the housing and a spring connected between the biasing plate and the front wall of the cassette, whereby upon an outward driving of the handle, the biasing plate will bias the stacking article outwardly to be discharged and collected by a holder.

15. A dispenser according to claim 1, wherein said housing includes a biasing plate which is connected with an actuating rod, whereby upon operation of the rod to allow the biasing plate to push the stacking article outwardly, the article will be discharged outwardly.
